(19) United States
(12) Patent Application Publication
(10) Pub. No.: US 2004/0189879 A1
(43) Pub. Date: Sep. 30, 2004

(54) Method and apparatus for switching television channels

(75) Inventor: Christopher Jensen Read, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Electronics Inc., Park Ridge, NJ (US)

(21) Appl. No.: 10/404,305

(22) Filed: Mar. 31, 2003

(51) Int. Cl. H04N 5/50

(52) U.S. Cl. 348/731; 348/706

(57) ABSTRACT

A system and method for switching television channels that includes a first tuner by which a current television channel is received and presented on a display, and a second tuner which tunes to other television channels digit by digit as a user is entering the digits. The current television channel continues to be presented on the display while the second tuner is tuning digit by digit until the user requests to view the television channel the second tuner is tuned to. In variations, a third tuner is implemented to tune to a predicted channel while the current television channel is presented on the display, and the predicted channel tuned by the third tuner is presented on the display when the user requests to view the predicted channel.

### BACKGROUND OF THE INVENTION

The present invention relates to television channel switching, and more particularly to television channel switching in digital television. Even more particularly, the present invention relates to the relatively large amount of time required and the display of blank or otherwise non-program periods in the switching of channels in digital television.

Television (TV) viewers perceive seamless, rapid switching from one channel to another to be an important TV receiver characteristic, and have become accustomed to seamless, rapid switching from one channel to another in analog television. This type of channel switching is generally effected by pressing a “channel up” (“up” or “+”) or “channel down” (“down” or “−”) key on a control (such as a remote control) for a television.

With the high number of channels now available to viewers for viewing, searching serially (e.g., in ascending or descending numerical order) through multiple channels quickly becomes desirable, so that viewers can find their desired programming in an efficient manner, without referring to a channel guide/schedule. This practice is known, in popular vernacular, as “channel surfing.”

Switching to another channel (either sequentially, or directly, i.e., “randomly”) to view alternate programming during, for example, commercials is also desirable for many viewers.

As the number of channels available to viewers increases, due for example to the introduction of technologies such as digital television (DTV), the desirability of seamless, rapid switching between channels increases.

Unfortunately, however, it is well known in the art that certain properties of digital television (DTV) make channel switching times, i.e., the periods between the selection and display of channels, longer than the channel switching times of traditional analog television, regardless of whether such channel switching is sequential or “random.”

The longer channel switching time is due to several factors involved with processing a digital television signal. The primary one being that in digital television there is a reference frame transmitted to the television (via, for example, a coaxial cable transmission line, or air channel, such as, for example, a satellite channel) generally only every 0.5 seconds. These reference frames are used to help digitally tune to a desired “channel” by acquiring a correct frequency and timing for the desired “channel.” As a result, in some cases, the viewer is presented with a blank or otherwise non-program screen (display) for 1 second or more when switching channels.

Thus, there is a need for systems and methods that provide for channel switching (including “channel surfing”) in, for example, digital television, with reduced or eliminated blank or otherwise non-program displays during channel switching, and furthermore with a reduced or zero time delay (during which a non-program display is presented to the viewer) required for the switching channels.

The present invention advantageously addresses the above and other needs.

### SUMMARY OF THE INVENTION

The present invention addresses the above and other needs by providing a system and method for switching channels.

In one embodiment, the present invention can be characterized as a method, and means for accomplishing the method, of switching television channels, the method including the steps of: receiving a current television channel by a first tuner; presenting the current channel from the first tuner on a display screen; receiving a first digit from a user wherein the first digit indexes a second television channel; and tuning with a second tuner, while the first tuner is receiving the current channel and while presenting the current channel from the first tuner on the display screen, to the second television channel before the user requests to view the second television channel.

In accordance with a variation of the one embodiment, the method comprises further steps and means for accomplishing the further steps, the further steps comprising: tuning with a third tuner to a predicted channel wherein the predicted channel is predicted based in part upon a previous request from the user to view a channel; switching to present on the display screen the predicted channel from the third tuner in response to the second channel being the same as the predicted channel and the user requesting to view the second channel; and switching to present on the display screen the second television channel from the second tuner in response to the second channel being different than the predicted channel and the user requesting to view the second channel.

In another embodiment, the present invention can be characterized as a channel switching system comprising: a first tuner configured to receive a current television channel; a second tuner configured to receive a plurality of television channels; a selection switch configured to present the current channel from the first tuner to a display screen; a microprocessor coupled with the first tuner, the second tuner and the selection switch, and the microprocessor is configured to: receive a first digit from a user wherein the first digit indexes a second television channel; and direct the second tuner, while the first tuner is receiving the current channel and the selection switch is presenting the current channel from the first tuner on the display screen, to tune to the second television channel before the user requests to view the second television channel.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram of a channel switching system in accordance with one embodiment of the present invention;

FIG. 2 is a block diagram of the channel switching system of FIG. 1 with one example of signal processing subsystems and interrelationships thereinbetween shown in detail;

FIG. 3 is a process flow chart showing a channel switching process of the channel switching system of FIG. 1 and FIG. 2;

FIG. 4A is a timeline showing switching between two tuners of the channel switching system of FIG. 1 and FIG. 2;

FIG. 4B is a timeline showing switching of channels using one tuner of a prior art conventional channel switching system;

FIG. 5 is a flowchart illustrating steps traversed by the channel switching system of FIG. 1 and FIG. 2 to tune a standby tuner, digit by digit, as a new channel is entered;

FIG. 6 is a block diagram of a channel switching system with three tuners in accordance with another embodiment of the present invention; and

FIG. 7 is a flowchart illustrating steps traversed by the channel switching system of FIG. 6 in accordance with one embodiment of the present invention.

### DETAILED DESCRIPTION OF THE PREFERRED EMBODIMENTS

The following description is of the best mode presently contemplated for carrying out the invention. This description is not to be taken in a limiting sense, but is made merely for the purpose of describing the general principles of the invention. The scope of the invention should be determined with reference to the claims.

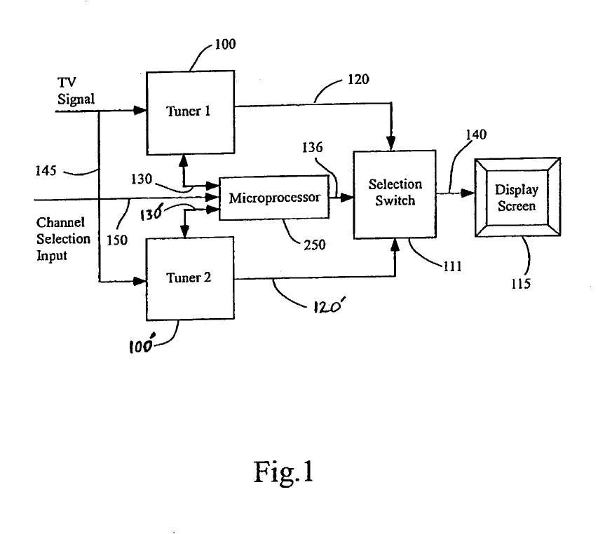

Referring to FIG. 1, shown is a block diagram of the channel switching system in accordance with one embodiment of the present invention. Shown is a first tuner 100, a second tuner 100′, a microprocessor 250, a selection switch 111 and a display screen 115.

There is an RF television signal input 145 to the first and second tuners 100, 100′ and a channel selection input 150 to the microprocessor 250. The first and second tuners 100, 100′ are coupled 120, 120′ to the selection switch 111. The tuners 100, 100′ are also coupled to the microprocessor 250 individually through separate duplex communication lines 130, 130′, respectively. The microprocessor 250 and display screen 115 are coupled 136, 140 to the selection switch 111.

The first tuner 100 and the second tuner 100′ receive an RF television signal input 145. The microprocessor 250 controls which channels are tuned by the tuners 100, 100′ and which output 120, 120′ from each tuner 100, 100′ is selected by the selection switch 111. The output 140 of the selection switch 111 (controlled by the microprocessor) is a television signal that is sent to the display screen 115 for display.

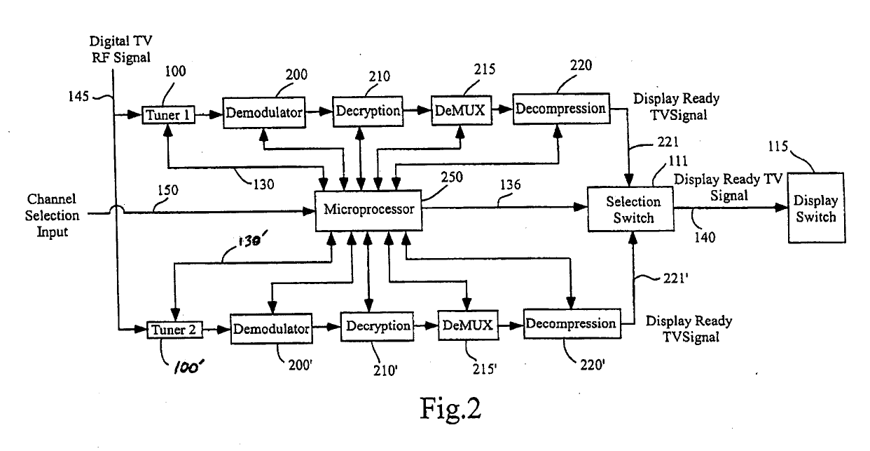

Referring next to FIG. 2, shown is a block diagram of the channel switching system of FIG. 1 with one example of signal processing subsystems and interrelationships therein between shown in detail. Shown are two signal paths. Each of the two parallel signal paths is substantially identical (therefore the components thereof are commonly numbered, with callout numbers of the components of one path carrying the prime (“′”) indicator). In the interest of conciseness, only one of the two parallel signal paths is described herein below, with the other of the two parallel signal paths being understood to be identical to the one of the two parallel signal paths, except as otherwise described or depicted. Each signal path includes a tuner 100, demodulator 200, a decryptor 210, a demultiplexer 215, and a video decompression module 220. Also shown is a single microprocessor 250, the selection switch 111 and display screen 115. Within each signal path, the tuner 100, demodulator 200, decryptor 210, demultiplexer 215 and decompression module 220 are individually coupled to the microprocessor 250 which is coupled 136 to the selection switch. Also, the tuner 100 is coupled to the demodulator 200 which is in turn coupled to the decryptor 210. The decryptor 210 is coupled to the demultiplexer 215 which is in turn coupled to the decompression module 220, and the decompression module 220 is coupled to the selection switch 111.

As explained above, the first tuner 100 and the second tuner 101′ receive an RF television signal input 145. Two television programs are extracted from the television signal input 145 by two parallel signal paths depicted in FIG. 2. Each of the two parallel signal paths shown includes a demodulator 200, a decryptor 210 a demultiplexer 215 and a decompression device 220, as are known in the art. As the respective signals pass through these devices, the microprocessor 250 coordinates the signal processing to produce a demodulated, decrypted and demultiplexed program signal. The microprocessor 250 initiates and coordinates decompression of the video for each of the program signals. Once these signals are decompressed, the decompression devices 220, 220′ output these two signals 221, 221′ for selective display by the television display screen 115.

These two television signals 221, 221′ are input to a selection switch 111 that is coupled 136 to the microprocessor 250 having a channel selection input 150 as in FIG. 1, described above. The selection switch 111 is controlled by the microprocessor 250 which takes into account the value of the channel selection input 150 and operates according to the channel switching process described below. The output 140 of the selection switch 111 is the television signal selected by the selection switch 111 to be sent to the display screen 115 for display.

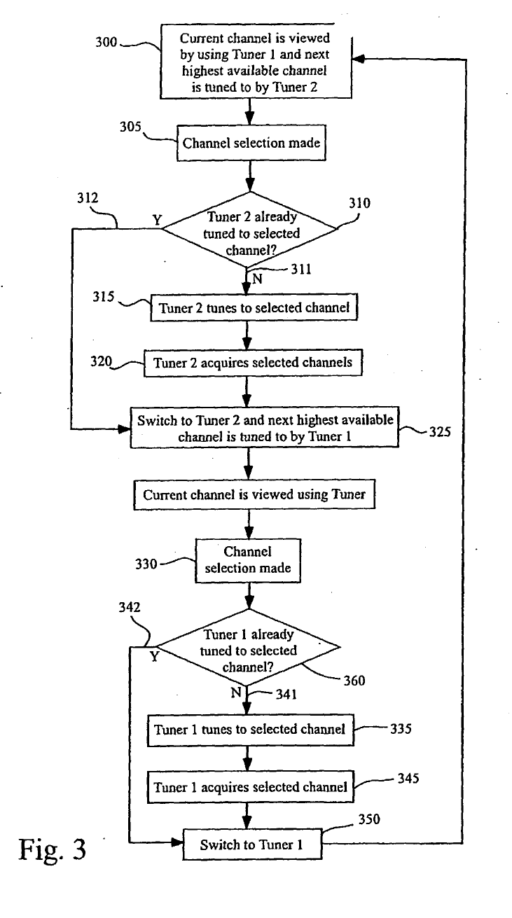

Referring now additionally to FIG. 3, shown is the channel switching process flow of the channel switching system of FIG. 1 and FIG. 2. Shown are blocks that represent the steps and decisions made during the channel switching process. The arrows point in order to the next step or decision to be made in the process.

By way of operation, a current channel is viewed 300 on the display screen 115 by receiving a signal 140 through the selection switch 111 ultimately from either the first tuner 100 or the second tuner 101′, e.g., the first tuner 100 in this case. By default, the tuner through which the current channel is not being viewed (also referred to herein as the standby tuner) e.g., the second tuner 101′ in this case, can be, for example, tuned 260 to the next highest available channel. This operation is controlled via the selection switch 111.

Although the present embodiment illustrated with reference to FIG. 3 indicates that the tuner through which the current channel is not being viewed, e.g., the second tuner 100′, is tuned to the next higher channel, it should be recognized that the tuner through which the current channel is not being viewed may be tuned to a predicted channel based upon a pattern of previous channel selections. U.S. patent application Ser. No. 10/164,141, of Bessel, et al., filed Jun. 4, 2002, for METHOD AND APPARATUS FOR SWITCHING TELEVISION CHANNELS, the entirety of which is hereby expressly incorporated herein by reference, describes some patterns that may be used to predict a future channel selection.

For example, the tuner through which the current channel is not being viewed, e.g., the second tuner 100′, can be, for example, tuned to a channel selected as a function of one or more of the following: dwell time (i.e., the length of time during which the viewer has viewed the current channel); a preselected or programmatically determined (such as determined as a function of the viewer viewing habits, e.g., a statistical analysis of the most probable next channel to be selected by the viewer); time of day; day of week; a previously viewed channel (e.g., if the viewer selected the current channel sequentially or nonsequentially, such as from a numeric keypad).

In an additional embodiment, the tuner through which the current channel is not being viewed, e.g., the second tuner 100′, is tuned to the most recent previous channel in response to the presently viewed channel, e.g., the present channel from the first tuner 100, being the channel before the most recent previous channel. In this way, when a user has set a pattern of switching back and forth between two channels, the standby tuner (i.e., the tuner through which the current channel is not being viewed) is tuned to the most recent previous channel so that when the user switches back to the most recent previous channel there is less, if any, delay.

The channel selected may alternatively or additionally be determined as a function of a viewer's direction (i.e., pattern) of sequentially tuning through channels, e.g., selecting a next higher channel for tuning by the tuner through which the current channel is not being viewed in the event the current channel was selected by pressing a “DOWN” button. The way in which the channel selected is determined, i.e., of what the channel selected is a function, may be automatically or manually adjusted as e.g., a function of user behavior or interaction.

When a channel selection is made 305, it is communicated to the microprocessor 250 via the channel selection input 150. If the second tuner 100′ is already tuned to that channel 310, 312 (such as may be the case when the viewer is scrolling sequentially up through the channels), the microprocessor 250 communicates 136 to the selection switch 111 to immediately switch 325 the display screen 115 input 140 from the output 221 originating from the first tuner 100 to the output 221′ originating from the second tuner 100′, thus effecting the channel change (channel switching). As a result, the channel selection is immediately reflected on the display screen 115.

If the second tuner 100′ is not already tuned to that channel 311 the microprocessor 250 communicates the channel selection to the second tuner 100′. The second tuner 100′ then tunes 315 to the channel (which, as mentioned above may take up to one second or more). Then, after the second tuner 100′ acquires 320 the channel and any corresponding signal processing is completed, the selection switch 111 switches 325 the display screen 115 input 140 from the output 221 originating from the first tuner 100 to the output 221′ originating from the second tuner 100′, thus effecting the channel change. As a result, during the period it takes for the second tuner 100′ to tune the channel 315, 320 the display screen 115 input 140 remains switched to the output 120 originating from the first tuner 100, and thus the display screen 115 does not appear blank or otherwise reflect non-program displays. Alternative embodiments also exist where the switch to the new channel can take place even though the tuning and signal processing are not complete. This would be, for example, in the case described above where the second tuner 100′ is not already tuned to the channel communicated through the channel selection input. In this case a blank or non-program screen is seen for a period of time until the tuning and signal processing are complete.

In either case, in preparation for a subsequent channel selection, the microprocessor 250 then communicates to the first tuner 100 to tune to a next higher channel 325 after the channel to which the second tuner 100′ is tuned. When another channel selection is made 330, the first tuner 100 will then tune to the desired channel 335, 341 (if not tuned already 340, 341 i.e.., if the other channel is not the next higher channel). Then (in the present embodiment once the first tuner 100 has acquired 345 the desired channel, if necessary), the display screen 115 input 140 is switched 350 by the control module 110 to the output 120 originating from the first tuner 100.

As discussed above, it should be recognized that in alternative embodiments the second tuner 100′ is tuned to a predicted channel in response to the selection of the presently viewed channel being part of a recognized pattern, e.g., the current channel being a sequential channel up from a most recent previous channel; the presently viewed channel being a sequential channel down from the most recent previous channel; the presently viewed channel being a channel the user requested to view immediately before the most recent previous channel.

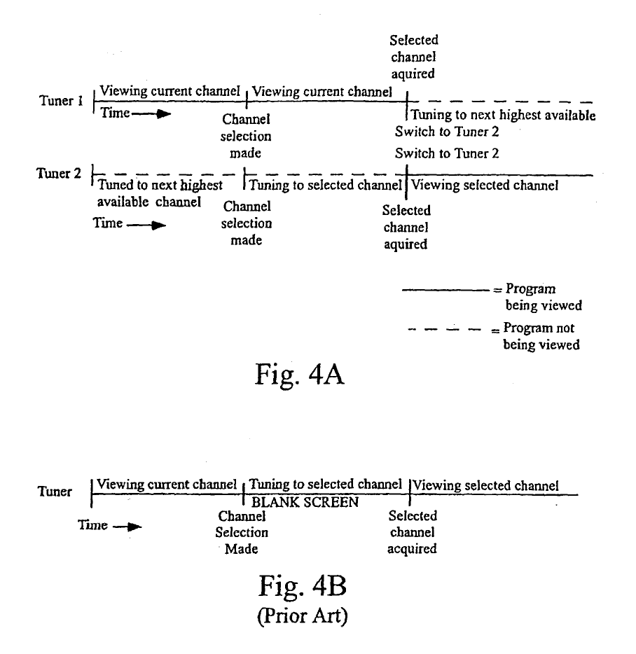

Referring next to FIG. 4A and FIG. 4B, shown in FIG. 4A is a timeline showing switching between two tuners of the channel switching system of FIG. 1 and FIG. 2. The state each is in at any given time is represented from left to right along the length of the horizontal line next to the name of the corresponding tuner. Shown in FIG. 4B is a timeline showing switching of channels using one tuner of a prior art conventional channel switching system. The state the tuner is in at any given time is represented from left to right along the length of the horizontal line.

As shown in FIG. 4A and FIG. 4B, the system and method of the present embodiment eliminates blank or otherwise non-program periods during channel switching, and reduces or eliminates the period between channel selection and display, i.e., reduces or eliminates the period required for channel switching (by “predicting” and “tuning to” a next channel, e.g., a next higher or a predicted channel, with the tuner 100 or 100′ to which the selection switch 111 is not switched).

As depicted in FIG. 4B, in conventional channel switching there is a blank or otherwise non-program period between selecting and displaying channels. This period results while the tuner (conventionally, a single tuner) tunes to and acquires the newly selected channel.

FIG. 4A shows that, in accordance with the present embodiment, while one tuner is tuning to a newly selected channel, a current channel is still being displayed using the other tuner, thus eliminating the blank or otherwise non-program period that would otherwise exist during channel switching.

Also, if the viewer selects a next highest available channel, say by scrolling up using a television remote control, the tuner through which the current program is not being viewed will, in accordance with one variation of the present embodiment, already be tuned to a next selected channel (i.e., next higher channel) and thus there will be no discernable switching time apparent to the viewer. This makes channel switching appear to the viewer to be virtually instantaneous (because the changing of the display from one channel to the next higher channel is nearly instantaneous).

In other embodiments, before the newly selected channel is displayed, a brief blank segment may intentionally be displayed to visually separate the current channel from the newly selected channel. This brief blank segment provides a visual cue to the user that the user's request to view the newly selected channel has been implemented.

As discussed above, in several embodiments, the tuner through which the current channel is not being viewed is tuned to a predicted channel, e.g., a sequential channel down from the presently viewed channel in response to the presently viewed channel being a sequential channel down from the most recent previous channel. There are occasions, however, when it is more difficult to predict what the user's next channel selection will be. For example, when the selection of the presently viewed channel was not part of a readily discernable pattern, it is difficult to predict with a reasonable level of certainty what the user's next selection will be.

According to several embodiments of the present invention, to expedite tuning of the standby tuner to a newly selected channel, the standby tuner is tuned digit by digit as a new channel is keyed in so that when the user requests to view the channel indexed by the keyed in digits, e.g., by pressing an “<enter>” or “<select>” key, the standby tuner has already started to tune to the selected channel before it is selected. Thus, when it is difficult to predict what channel a user will select next, in some embodiments, the standby tuner tunes digit by digit as a new channel is entered instead of staying tuned to a predicted channel. As used herein the term “digit” generally refers to a number, a letter and any other symbol. Thus, channels may be indexed by numbers, letters, symbols or a combination thereof and be well within the scope of the present invention.

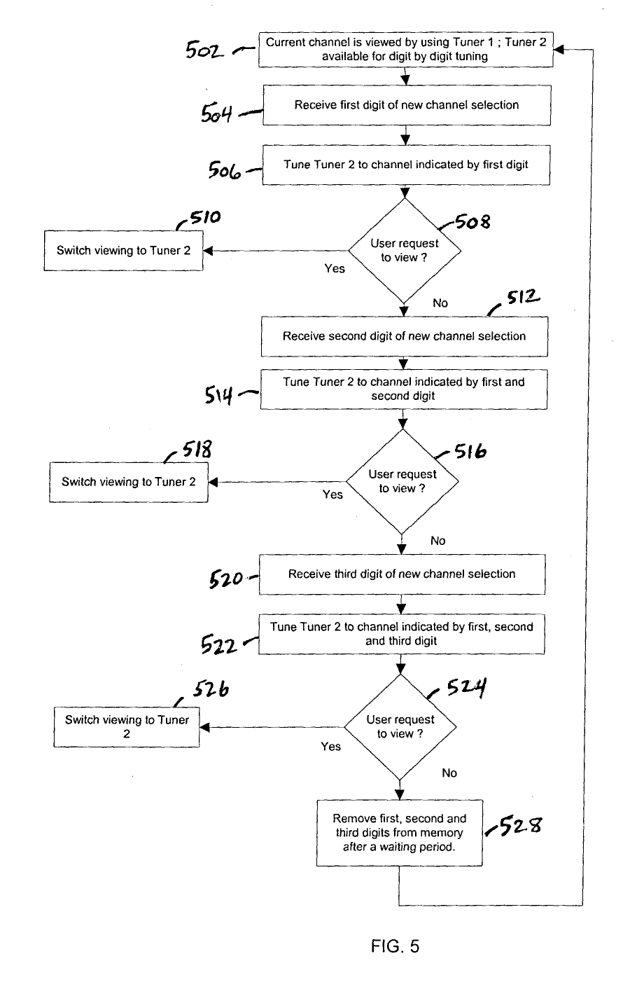

For example, FIG. 5 is a flowchart illustrating steps traversed by the channel switching system of FIG. 1 and FIG. 2 to tune a standby tuner, digit by digit, as a new channel is entered.

By way of operation, a current channel is viewed on the display screen 115 by receiving a signal 140 through the selection switch 111 ultimately from either the first tuner 100 or the second tuner 100′. In the present embodiment, the first tuner 100 is initially tuned to the current channel, i.e., the channel being displayed, and the second tuner 100′ is available as a standby tuner for tuning digit by digit to a new channel as it is entered by a user (Step 502). It should be recognized that the first tuner is described as the one tuning to the displayed channel for exemplary purposes only and that the second tuner 100′ in several embodiments is initially the tuner through which the present cannel is displayed. Thus, the first tuner 100 in several embodiments functions as a standby tuner available for digit by digit tuning.

When the user enters a first digit of a new channel, e.g., by keying in a digit with a keypad, the channel switching system receives the first digit (Step 504), and the second tuner 100′ tunes to the channel indexed by the first digit (Step 506). For example, if the user first presses a <2> button, the second tuner 100′ begins to tune to channel 2.

If the user subsequently requests to view the channel indexed by the first digit (Step 508) by, e.g., hitting an <enter> key or another key with similar functionality, then the selection switch 111 switches the signal path that includes the second tuner 100′, and hence, the channel indexed by the first digit over to the display screen 115 (Step 510). For example, if the first digit was a “2” then channel 2 is displayed on the display screen.

If the user does not request to view the channel indexed by the first digit (Step 508), and the channel switching system receives a second digit of a new channel from the user (Step 512), the second tuner 100′ tunes to the channel indexed by the combination of the first and second digit (Step 514). For example, if the first digit entered is a “2,” and the second digit entered is a “3,” then the second tuner will tune to channel 23.

If the user requests to view the channel indexed by the first and second digits after the first and second digits are entered (Step 516), the channel indexed by the combination of the first and second digits is presented to the display screen 115 (Step 510). For example, if the first digit entered is a “2,” and the second digit entered is a “3,” then channel 23 is presented to the display screen 115.

If instead of requesting to view the channel indexed by the first and second digits, the user keys in a third digit, then the second tuner stops tuning to the previous channel indexed by the combination of the first and second digits, and tunes to a channel indexed by the combination of the first, second and third digits (Step 522). For example, if the first digit entered is a “2,” the second digit entered is a “3,” and the third digit entered is a “1,” then the second tuner 100′ tunes to channel 231.

If the user requests to view the channel indexed by the first, second and third digits (Step 524), then the channel indexed by the combination of the first, second and third digits is presented to the display screen 115 (Step 526). For example, if the first digit entered is a “2,” the second digit entered is a “3,” and the third digit entered is a “1,” then channel 231 is presented to the display screen 115.

In several embodiments, the channel switching system also tunes to a combination of digits as a user deletes one or more digits. For example, if a user has already input “231,” but has not yet requested to view the channel indexed by “231,” and the user then deletes a digit, e.g., deletes the “1” digit, by using, e.g., a “<backspace>” key, the standby tuner will then tune to channel “23.”In some embodiments, the tuning described with reference to Steps 506, 514 and 522 of FIG. 5 is simply a tuning of a tuner, e.g., tuner 100 or 100′, to the frequency that carries the channel indexed by the entered digits. In other embodiments, the tuning described with reference to Steps 506, 514 and 522 of FIG. 5 includes both tuning of a tuner and at least a portion of signal processing of the tuned signal, i.e., the tuning in these steps includes one or more of the signal processing steps described with reference to FIGS. 1 and 2.

In one embodiment for example, content received by the channel switching system is compressed according to MPEG-2 standards, and as each digit is entered, the channel indexed by the entered digits is tuned, and the signal is demodulated, demultiplexed and an I-frame of the signal is detected. In this way, when the user requests to view the channel that a standby tuner is tuned to, much of the signal processing that ordinarily delays a display of content provided over a channel has already been carried out.

As discussed, channels need not be indexed by numbers only, and in some embodiments channels are indexed by letters. For example, a channel may be indexed by “ABC,” and when a user enters “A” the standby tuner tunes to the channel indexed by “A,” and when the user enters “B” the standby tuner tunes to the channel indexed by “AB,” and when the user enters “ABC” the standby tuner tunes to the channel indexed by “ABC.”

In other embodiments, channels are indexed by a combination letters, numbers or symbols. For example, channels may be indexed as “12A,” “12A*”, “12B,” “12C” and so on, and as each digit, whether numeric, alphabetic, or symbolic is entered, the standby tuner tunes to the channel indexed by the combination of entered digits.

In several other embodiments, the channel switching system is designed to receive multi-program transport streams over a single RF channel. The Advanced Television Systems Committee (ATSC) has established a two-part channel numbering scheme made up of major channel numbers that are used to group all services that are broadcast over a single RF channel and associated with a broadcaster's National Television System Committee (NTSC) brand, for example Channel 4. In contrast, a minor channel number indexes a particular sub-channel within that group. Potential minor channel numbers include 1-999 with 0 being reserved for the NTSC channel.

In these embodiments, the tuning referred to in Steps 506, 514 and 522 of FIG. 5 may be either RF tuning (e.g., by the tuners 100, 100′) to tune to an major channel number, or digital signal processing to tune to (e.g., filter out) one of the multiple programs (indexed by a minor channel number), or may be a combination of both RF tuning and digital signal processing. For example, once a tuner is tuned to a particular channel indexed by a major channel number, only digital signal processing need be done to extract the desired program indexed by a minor channel number. In several embodiments, for example, sub-channel tuning includes PID filtering as is well known in the art.

According to the ATSC channel numbering scheme, the major channel numbers are delimited from the minor channel numbers by a specific character, e.g., a decimal point “.” or a dash “-”. Thus, in several embodiments, when the user inputs a “2”, for example, the standby tuner tunes to the RF channel indexed by the major channel number “2,” and if a user then follows the “2” with a specified delimiter e.g., a decimal point “.” or a dash “-”, then the next digit entered by the user is taken as a minor channel number by the channel switching system. Thus, when a user has entered “2-1”, for example, the channel (i.e., the sub-channel indexed by minor channel number “1”) within the channel indexed by the major channel “2” is tuned to by the standby tuner.

In some the discussed embodiments, if the user does not request to view a channel indexed by, e.g., a first, second and third digits, then after a period of time, e.g., a few seconds, the first, second and third digits are removed from the channel switching system's memory (Step 528). In this way, when the user inputs another digit it is not combined with the first, second and third digits. Although the channel switching system in the present embodiment is described as supporting entry of three digits, it should be recognized that the present invention is easily adapted to tune digit by digit to channels indexed by four or more digits.

It should also be recognized that in some embodiments, the steps set forth with reference to FIG. 5 represent an alternative channel switching scheme to the steps described with reference to FIG. 3, and in other embodiments, the steps set forth with reference to FIG. 5 augment the channel switching scheme illustrated with reference to FIG. 3.

In some embodiments for example, the digit by digit tuning approach of FIG. 5 is used for the standby tuner when it is difficult to predict what the next channel the user is going to request to view. For example, if the current channel at Step 300 of FIG. 3 is not part of a recognized pattern of channel selections, i.e., a pattern that provides a reasonable level of probability as to what channel the user will request to view next, then the channel selection system follows Steps 502 through 528 of FIG. 5 instead of the Steps outlined with reference to FIG. 3.

Similarly, if the current channel is outside of a recognized pattern and the user requests to view a new channel indexed by either the first digit; the first and second digits; or the first, second and third digits and the new channel is now part of a pattern, e.g., the new channel is the channel the user was viewing just before the current channel, then the channel selection system follows steps 300 through 350 of FIG. 3. In this way, if there is a substantial likelihood that the user will request to view a particular channel, then the second tuner 100′ is tuned to that particular channel, otherwise the second tuner 100′ tunes digit by digit as a user enters each digit so that when the user does request to view the channel indexed by the digits, the second tuner 100′ has already begun to tune to that channel.

In some embodiments, in addition to providing digit by digit tuning, the standby tuner is also utilized to tune, by default, to a channel that is referenced by a predefined button. In one embodiment for example, unless the user starts entering digits to tune to a new channel, the standby tuner remains tuned to a channel referenced by a “back” button, which is a button predefined to allow the user to view the last previously tuned channel simply by pressing the “back” button. In this embodiment, after a new frequency is tuned, the old frequency is kept on the standby tuner. Then if the “back” button is pressed, the display can quickly show the prior channel again. This is especially useful with digit-by-digit tuning, because guesses at the next channel to be tuned are more difficult than with channel-up or channel-down.

In other embodiments, the channel switching system includes three tuners, and one tuner is used to provide a current channel that is displayed, a second standby tuner is used to tune to a predicted channel and a third standby tuner is used to tune digit by digit to a new channel. In this way, if a user makes a new channel selection that happens to be the predicted channel, the second tuner is already tuned to the new channel, but if the new channel is not the predicted channel, then the third tuner will be able to quickly display the new channel.

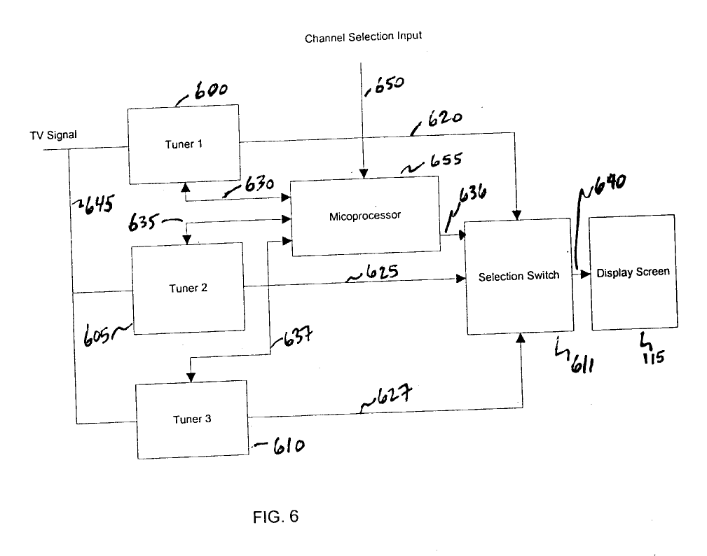

For example, referring to FIG. 6, shown is a block diagram of a channel switching system with three tuners in accordance with another embodiment of the present invention. Shown is a first tuner 600, a second tuner 605, a third tuner 610, a microprocessor 655, a selection switch 611 and the display screen 115.

There is an RF television signal input 645 to the first, second and third tuners 600, 605, 610 and a channel selection input 650 to the microprocessor 655. The first, second and third tuners 600, 605, 610 are coupled 620, 625, 627 to the selection switch 611. The tuners 600, 605, 610 are also coupled to the microprocessor 655 individually through separate duplex communication lines 630, 635 and 637 respectively. The microprocessor 655 and display screen 115 are coupled 636, 640 to the selection switch 611.

The first, second and third tuners 600, 605, 610 receive an RF television signal input 645. The microprocessor 655 controls which channels are tuned by the tuners 600, 605, 610 and which output 620, 625, 627 from each tuner 600, 605, 610 is selected by the selection switch 611. The output 640 of the selection switch 611 (controlled by the microprocessor) is a television signal that is sent to the display screen 115 for display.

The channel switching system of the present embodiment is similar to the channel switching system discussed with reference to FIGS. 1 and 2, except for a third signal path that includes the third tuner 610. Subcomponents of each signal path, i.e., a tuner, demodulator, decryptor, demultiplexer, and a video decompression module are discussed with reference to FIG. 2, and thus are not described further herein.

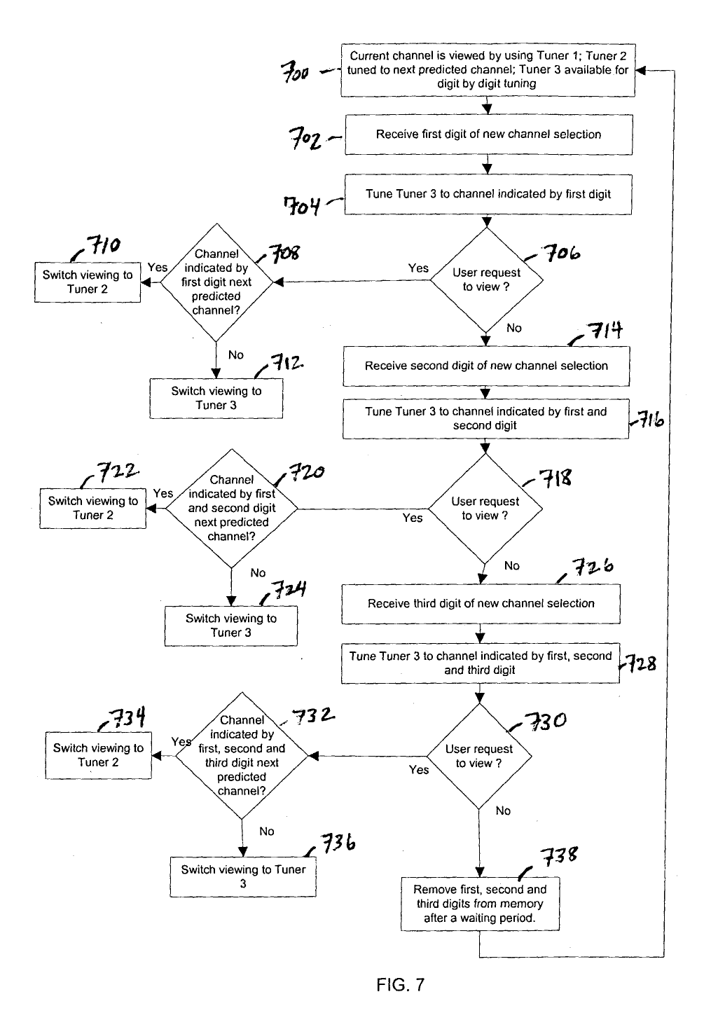

While referring to FIG. 6, simultaneous reference will be made to FIG. 7 which is a flowchart illustrating steps traversed by the channel switching system of FIG. 6 in accordance with one embodiment of the present invention.

Initially, after a user has selected a currently viewed channel, the first tuner 600 provides the current channel to the display screen 115, the second tuner 605 is tuned to a predicted channel and the third tuner 610 is available for digit by digit tuning (Step 700).

When the user enters a first digit of a new channel, e.g., by keying in a digit with a keypad, the channel switching system receives the first digit (Step 702) via the channel selection input 650, and the third tuner 610 tunes to the channel indexed by the first digit (Step 704).

If the user subsequently requests to view the channel indexed by the first digit (Step 706), e.g., by hitting an <enter> key and the channel indexed by the first digit is a predicted channel (Step 708) then the selection switch 611 switches the signal path that includes the second tuner 605, and hence, the channel indexed by the first digit, over to the display screen 115 (Step 710).

If the channel indexed by the first digit is not the predicted channel (Step 708), then the selection switch 611 switches the signal path that includes the third tuner 610 to the display screen 115.

If after keying in the first digit, the user has not requested to view the channel indexed by the first digit (Step 706), and the channel switching system receives a second digit of a new channel from the user (Step 714), the third tuner 610 tunes to the channel indexed by the combination of the first and second digit (Step 716).

If the user requests to view the channel indexed by the first and second digits (Step 718), and the channel indexed by the combination of the first and second digits is the next predicted channel (Step 720), then the selection switch 611 switches the signal path that includes the second tuner 605, and hence, the channel indexed by the first and second digits over to the display screen 115 (Step 722).

If the channel indexed by the first and second digit is not the predicted channel (Step 720), then the selection switch 611 switches the signal path that includes the third tuner 610 to the display screen 115 (Step 724).

If after keying in the first and second digits, the user has not requested to view the channel indexed by the first and second digits (Step 718), and the channel switching system receives a third digit of a new channel from the user (Step 726), the third tuner 610 tunes to the channel indexed by the combination of the first, second and third digits (Step 728).

If the user requests to view the channel indexed by the first, second and third digits (Step 730), and the channel indexed by the combination of the first, second and third digits is the next predicted channel (Step 732), then the selection switch 611 switches the signal path that includes the second tuner 605, and hence, the channel indexed by the first, second and third digits over to the display screen 115 (Step 734).

If the channel indexed by the first, second and third digits is not the predicted channel (Step 732), then the selection switch 611 switches the signal path that includes the third tuner 610 to the display screen 115 (Step 736).

In one embodiment, if the user does not request to view the channel indexed by the first, second and third digits, then after a period of time, e.g., a few seconds, the first, second and third digits are removed from the channel switching system's memory (Step 738). In this way, when the user inputs another digit it becomes the first digit and is not combined with the first, second and third digits.

While the invention herein disclosed has been described by means of specific embodiments and applications thereof, numerous modifications and variations could be made thereto by those skilled in the art without departing from the scope of the invention set forth in the claims.

For example, the embodiment and variation described above refer to tuning a first tuner to one channel for display, and tuning a second tuner to a next higher channel, so that in the event the user selects the next higher channel the change in the display from the one channel to the next higher channel can be nearly instantaneous. A further variation may include tuning the second tuner to a next lower channel in the event the viewer is “channel surfing” (sequentially tuning) down through channels, rather than sequentially up through channels, as assumed above.

Yet a further variation may include tuning the second tuner to a next higher/lower channel in a selected set of channels (channel group), such as, e.g., a news channel group.

In other variations, multiple standby tuners are available and a portion of these standby tuners are utilized to tune, by default, to channels that are referenced by a predefined buttons. In one embodiment for example, one standby tuner remains tuned to a channel referenced by a “back” button, another standby tuner remains tuned to a channel referenced by a button programmed with a user's favorite channel, a third standby tuner is utilized to tune to a predicted channel and a fourth tuner is available for either digit by digit tuning and/or a predefined button.

What is claimed is:

1. A method for switching television channels comprising the steps of:
receiving a current television channel by a first tuner;
presenting the current channel from the first tuner on a display screen;
receiving a first digit from a user wherein the first digit indexes a second television channel; and
tuning with a second tuner, while the first tuner is receiving the current channel and while presenting the current channel from the first tuner on the display screen, to the second television channel before the user requests to view the second television channel.

2. The method of claim 1, further comprising the step of:
receiving a second digit from the user after the step of receiving the first digit wherein a combination of the first and second digits are an index to a third television channel;
wherein the step of tuning with the second tuner comprises, after the second digit is received and while the first tuner is receiving the current channel, tuning with the second tuner to the third television channel before the user requests to view the third television channel.

3. The method of claim 2, further comprising the step of:
switching, in response to the user requesting to view the third television channel, from a display of the current television channel to a display of the third television channel.

4. The method of claim 1, wherein the step of tuning with the second tuner to the second television channel indexed by the first digit is in response to a request from the user to view the current channel being outside a recognized pattern.

5. The method of claim 4, wherein the recognized pattern is selected from the group consisting of: the current television channel being a sequential channel up from a most recent previous channel which the user requested to view immediately prior to the current channel; the current television channel being a sequential channel down from the most recent previous channel; the current television channel being a channel the user requested to view immediately prior to the most recent previous channel.

6. The method of claim 5, further comprising the steps of:
tuning the second tuner to a sequential channel up from the current television channel in response to the current television channel being a sequential channel up from the most recent previous channel;
tuning the second tuner to a sequential channel down from the current television channel in response to the current television channel being a sequential channel down from the most recent previous channel; and
tuning the second tuner to the most recent previous channel in response to the current television channel being the channel the user requested to view immediately prior to the most recent previous channel.

7. The method of claim 1, further comprising the step of:
tuning with a third tuner to a predicted channel wherein the predicted channel is predicted based in part upon a previous request from the user to view a channel;
switching to present on the display screen the predicted channel from the third tuner in response to the second channel being the same as the predicted channel and the user requesting to view the second channel; and
switching to present on the display screen the second television channel from the second tuner in response to the second channel being different than the predicted channel and the user requesting to view the second channel.

8. The method of claim 1, wherein the step of tuning with the second tuner comprises decrypting and demultiplexing digital content received via the second television channel.

9. A channel switching system comprising:
a first tuner configured to receive a current television channel;
a second tuner configured to receive a plurality of television channels;
a selection switch configured to present the current channel from the first tuner to a display screen;
a microprocessor coupled with the first tuner, the second tuner and the selection switch, wherein the microprocessor is configured to:
receive a first digit from a user wherein the first digit indexes a second television channel; and
direct the second tuner, while the first tuner is receiving the current channel and the selection switch is presenting the current channel from the first tuner on the display screen, to tune to the second television channel before the user requests to view the second television channel.

10. The channel switching system of claim 9, wherein the microprocessor is further configured to:
receive a second digit from the user wherein a combination of the first and second digits indexes a third television channel; and
direct the second tuner, while the first tuner is receiving the current channel and the selection switch is presenting the current channel from the first tuner on the display screen, to tune to the third television channel before the user requests to view the third television channel.

11. The channel switching system of claim 9, further comprising:
a third tuner configured to tune to a predicted channel;
wherein the microprocessor is configured to establish the predicted channel based in part upon previous requests received from a user to view a television channel prior to the user requesting to view the current channel.

12. The channel switching system of claim 11, wherein the microprocessor is configured to establish the predicted channel based in part upon previous requests received from the user wherein the previous requests received from the user are selected from the group consisting of: the user requesting to view the current television channel after requesting to view a most recent previous channel which is a sequential channel down from the current channel; the user requesting to view the current television channel after requesting to view a most recent previous channel which is a sequential channel up from the current channel; the user requesting to view the current television channel after requesting to view the most recent previous channel wherein the user requested to view the most recent previous channel after requesting to view the current channel.

13. The channel switching system of claim 9 further comprising:
a demultiplexor configured to demultiplex video and text components of the current television channel before presenting the current channel on the display screen; and
a decompression portion configured to decompress the video component of the current television channel before presenting the current channel on the display screen.

14. A channel switching system comprising:
means for receiving a current television channel;
means for presenting the current channel on a display screen;
means for receiving a first digit from a user wherein the first digit indexes a second television channel; and
means for tuning, while the current channel is presented on the display screen, to the second television channel before the user requests to view the second television channel.

15. The channel switching system of claim 14, wherein the means for receiving comprises, after receiving the first digit, means for receiving a second digit from the user, wherein a combination of the first and second digits are an index to a third television channel;
wherein the means for tuning comprises, while the means for presenting is presenting the current television channel to the display screen, means for tuning with the second tuner to the third television channel before the user requests to view the third television channel.

16. The channel switching system of claim 15, further comprising:
means for switching from a display of the current television channel to a display of the third television channel in response to the user requesting to view the third television channel.

17. The channel switching system of claim 14, wherein the means for tuning to the second television channel indexed by the first digit comprises means for tuning to the second television channel in response to a request from the user to view the current channel being outside a recognized pattern.

18. The channel switching system of claim 17, wherein the recognized pattern is selected from the group consisting of: the current television channel being a sequential channel up from a most recent previous channel, the most recent previous channel being a channel which the user requested to view immediately prior to the current channel; the current television channel being a sequential channel down from the most recent previous channel; and the current television channel being a channel the user requested to view immediately prior to the most recent previous channel.

19. The channel switching system of claim 18, further comprising:
means for tuning the second tuner to a sequential channel up from the current television channel in response to the current television channel being a sequential channel up from the most recent previous channel.

20. The channel switching system of claim 18, further comprising:
means for tuning the second tuner to the most recent previous channel in response to the current television channel being the channel the user requested to view immediately prior to the most recent previous channel.

21. The channel switching system of claim 14, further comprising:
means for tuning with a third tuner to a predicted channel wherein the predicted channel is predicted based in part upon a previous request from the user to view a channel;
means for switching to present on the display screen the predicted channel from the third tuner in response to the second channel being the same as the predicted channel and the user requesting to view the second channel; and
means for switching to present on the display screen the second television channel from the second tuner in response to the second channel being different than the predicted channel and the user requesting to view the second channel.
